(19) United States
(12) Patent Application Publication
(10) Pub. No.: US 2021/0251266 A1
(43) Pub. Date: Aug. 19, 2021

(54) EDIBLE AND FLAMMABLE FOOD PRODUCT

(71) Applicant: Anthony House, Pittsboro, NC (US)

(72) Inventor: Anthony House, Pittsboro, NC (US)

(21) Appl. No.: 16/793,892

(22) Filed: Feb. 18, 2020

(51) Int. Cl. A23L 25/00; A23L 33/15; A23L 33/29; A23L 5/10

(52) U.S. Cl. CPC A23L 25/00; A23L 33/15; A23L 33/30; A23L 5/11; A23L 5/15; A23L 33/29

(57) ABSTRACT

The presently disclosed subject matter is generally directed to an edible food product that can be readily burned as a fuel source, such as during camping or hiking. The term “edible” refers to a material that that can be ingested and that is safe for humans to eat. Particularly, the disclosed food product comprises one or more types of nuts, wafers, and/or sweeteners. The ingredients give the food product a high level of nutrition, providing energy and calories for use during a wide variety of activities (e.g., hiking). In addition, the disclosed food product is flammable, and easily burn or be set on fire, such as for use as a fuel (e.g., heat) source.

### TECHNICAL FIELD

The presently disclosed subject matter is generally directed to a food product that is both edible and flammable.

### BACKGROUND

Outdoor recreational activities continue to grow in popularity in the United States and throughout the world. Particularly, it is estimated that approximately 50 million people enjoyed camping and/or hiking in 2019 in the United States. Campers and hikers typically bring a set amount of food for consumption during each outing. Commonly, granola is packed as a food source due to its durability during travel, high levels of nutrition, and portability. Granola-based products typically include rolled oats, binders, nuts, and other ingredients to enhance taste or dietary factors. One of the most popular camping and hiking activities is the building of a campfire. However, gathering wood, sticks, and other combustible materials to build the fire is time-consuming and can be dangerous if the camper strays too far or encounters an animal. It would therefore be beneficial to provide a portable food product that is both nutritional and can be used during the fire-building process, thereby saving time and energy.

### SUMMARY

In some embodiments, the presently disclosed subject matter is directed to a food product. Particularly, the food product comprises about 5-95 weight percent of one or more nuts, about 5-70 weight percent of one or more wafers, and about 0.1-5 weight percent of one or more sweeteners, based on the total weight of the food product. The food product is also flammable.

In some embodiments, the food product can further comprise about 0.1-5 weight percent of one or more additives, based on the total weight of the food product, wherein the one or more additives are selected from the group consisting of one or more seeds, spices, oils, dried fruits, candies, preservatives, vitamins, minerals, colorings, herbal additives, antimicrobials, or flavorings.

In some embodiments, the food product comprises a moisture content of about 0-5 weight percent, based on the total weight of the food product.

In some embodiments, the food product is configured in loose, clustered, or bar form.

In some embodiments, the nuts are selected from pecans, almonds, cashews, pistachios, peanuts, macadamia nuts, hazelnuts, chestnuts, filberts, palm nuts, pine nuts, brazil nuts, or combinations thereof.

In some embodiments, the wafers are selected from corn chips, tortilla chips, potato chips, crackers, pretzels, croutons, breakfast cereals, popcorn, rice cakes, or combinations thereof.

In some embodiments, the sweeteners are selected from natural sugars, artificial sugars, or combinations thereof.

In some embodiments, the one or more of the nuts, wafers, and sweeteners are baked, fried, seared, or smoked. In some embodiments, the food product is baked at a temperature of about 200-500° C. for about 1-90 minutes.

In some embodiments, the food product comprises less than about 15 grams of fat per serving.

In some embodiments, the food product comprises less than about 5 grams of saturated fat per serving.

In some embodiments, the food product comprises less than about 20 grams of carbohydrates per serving.

In some embodiments, the food product comprises about 1-10 grams of fiber and about 2-20 grams whole grains per serving.

In some embodiments, the food product comprises about 1-12 grams of protein per serving.

In some embodiments, the presently disclosed subject matter is directed to a method of starting a fire. Particularly, the method comprises contacting a flammable food product with a fire source and allowing the food product to burn, thereby starting a fire. The food product comprises about 5-95 weight percent of one or more nuts, about 5-70 weight percent of one or more wafers, and about 0.1-5 weight percent of one or more sweeteners, based on the total weight of the food product.

In some embodiments, at least about 90 percent of the food product burns.

In some embodiments, the food product is configured in loose, clustered, or bar form.

In some embodiments, the food product has a moisture content of about 0-5 weight percent, based on the total weight of the food product.

In some embodiments, the food product has been baked, fried, seared, or smoked. In some embodiments, the food product has been baked at a temperature of about 200-500° C. for about 1-90 minutes.

### BRIEF DESCRIPTION OF THE DRAWINGS

FIG. 1 is a perspective view illustrating a flammable food product in accordance with some embodiments of the presently disclosed subject matter.

FIG. 2 is a schematic illustrating one embodiment of making a flammable food product in accordance with some embodiments of the presently disclosed subject matter.

FIG. 3 is a perspective view illustrating a food product in bar form in accordance with some embodiments of the presently disclosed subject matter.

FIG. 4 is a schematic illustrating one method of making a flammable food product in accordance with some embodiments of the presently disclosed subject matter.

FIGS. 5a and 5b are front plan views illustrating one embodiment of using the food product as a fuel source.

FIGS. 5c and 5d are front plan views illustrating an alternate embodiment of using a food product as a fuel source.

FIG. 6 is a front plan view illustrating a method of enhancing a fire in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

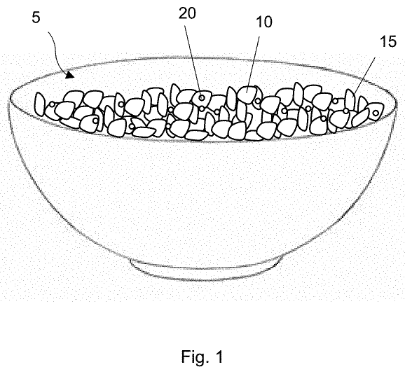

The presently disclosed subject matter is generally directed to an edible food product that can be readily burned as a fuel source, such as during camping or hiking. The term “edible” refers to a material that that can be ingested and that is safe for humans to eat. FIG. 1 illustrates one embodiment of food product 5 comprising one or more types of nuts 10, wafer 15, and/or sweetener 20. The ingredients give food product 5 a pleasing taste as well as a high level of nutrition and provides energy and calories for use during hiking or other recreational activities. In addition, food product 5 is flammable. The term “flammable” refers to a material that can easily burn or be set on fire, such as for use as a fuel (e.g., heat) source.

As set forth above, food product 5 can include one or more nuts 10. The term “nut” refers to any kernel found within an inedible hard shell. Suitable nuts can therefore include (but are not limited to) pecans, almonds, cashews, pistachios, peanuts, macadamia nuts, hazelnuts, chestnuts, filberts, palm nuts, pine nuts, brazil nuts, or combinations thereof. Food product 5 can therefore include any known type of nut. Nuts 10 are typically shelled, with or without skins. It should be appreciated that some shelled nuts are skinless (such as cashews), while others have skins (such as peanuts and almonds). Optionally, the nuts can be mechanically dry blanched to remove the skins prior to use in food product 5.

The food product can include about 5-95, 10-85, 15-75 or 25-60 weight percent nuts, based on the total weight of the food product. Thus, the food product can include at least about (or no more than about) 5, 10, 15, 20, 25, 30, 35, 40, 45, 50, 55, 60, 65, 70, 75, 80, 85, 90, or 95 weight percent of one or more nuts 10, based on the total weight of the food product. It should be appreciated that the presently disclosed subject matter is not limited and the food product can be produced with a larger or smaller amount of nuts 10.

Nuts 10 can be in any desired form, such as dry roasted, oil roasted, blanched, unblanched, full fat, partially de-fatted, raw, fried, and the like. The term “roasted” refers to cooking a material by direct exposure to dry heat such as in an oven (“dry roasting”) or in oil (“oil roasting”). The term “raw” refers to a material that has not been cooked or otherwise exposed to excessive heat. The term “fried” refers to a method of cooking a material with heat in fat or oil. The term “blanched” refers to scalding in boiling water and then plunging into cold or iced water.

In some embodiments, nuts 10 can be chopped or otherwise reduced in size. For example, in some embodiments, the nuts and/or wafers can be chopped to be of a uniform size (e.g., about the same size).

As set forth above, food product 5 can further include one or more wafers 15, such as one or more potato, corn, rice, barley, oat, rye, and/or wheat snack-type foods. Wafer 15 can thus include (but is not limited to) one or more corn chips, tortilla chips, potato chips, crackers, pretzels, croutons, breakfast cereals, popcorn, rice cakes, and the like. The term “wafer” therefore generally refers to a wide variety of starchy and/or carbohydrate-rich snack foods.

Product 5 can include wafer 15 in any desired form, such as (but not limited to) fried, baked, seared, and the like. In some embodiments, the food product can have a variety of wafer combinations, such as a baked wheat cracker and a fried corn chip.

The food product can include about 5-70, 10-65, 15-55 or 25-50 weight percent wafer 15, based on the total weight of the food product. Thus, the product can include at least about (or no more than about) 5, 10, 15, 20, 25, 30, 35, 40, 45, 50, 55, 60, 65, or 70 weight percent wafer(s) 15, based on the total weight of the food product. However, the presently disclosed subject matter is not limited and the food product can be produced with a larger or smaller amount of wafer 15.

Food product 5 further includes one or more sweeteners 20. The term “sweetener” refers to a material comprising one or more carbohydrate sugars (e.g., fructose), sugar alcohols, and the like that impart a recognizable sweet taste to a food product. Suitable sweeteners can include natural sugars (e.g., those found naturally in foods) and/or artificial sweeteners (e.g., those artificially produced). Natural sugars can therefore comprise one or more of sucrose, dextrose, maltose, fructose, and the like, such as those found in white sugar, brown sugar, raw sugar, honey, molasses, fruit, and the like. Suitable artificial sugars can include aspartame, saccharin, stevia, sucralose, sugar alcohols, and the like.

Sweetener 20 can be provided in any form, such as dried (solid, granular), liquid (such as molasses or honey) or combinations thereof.

Food product 5 can have any desired amount of sweetener 20. For example, in some embodiments, the food product can include about 0.1-10, 0.2-5, or 0.3-3 weight percent sweetener, based on the total weight of the food product. Thus, the food product can comprise at least about (or no more than about) 0.1, 0.5, 1, 1.5, 2, 2.5, 3, 3.5, 4, 4.5, 5, 5.5, 6, 6.5, 7, 7.5, 8, 8.5, 9, 9.5, or 10 weight percent sweetener (based on the total weight of food product 5). However, the presently disclosed subject matter is not limited and the sweetener can be present in an amount outside the range set forth above. For example, when a savory product is desired, the food product can have less than 0.1 weight percent sweetener.

Food product 5 can further include one or more optional ingredients, such as (but not limited to) seeds, spices, oils, dried fruit, candy, additives, and the like. The optional ingredients can make up about 0.1-10, 0.5-8, 1-5, or 1.5-3 weight percent of the food product (e.g., at least about/no more than about 0, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10 weight percent, based on the total weight of the food product).

Thus, the food product can include one or more seeds, including (but not limited to) pumpkin seeds, sunflower seeds, chia seeds, fennel seeds, sesame seeds, flax seeds, hemp seeds, and the like. The term “seed” broadly refers to any embryonic plant enclosed in a protective outer covering.

The food product can optionally include one or more spices, such as (but not limited to) salt, pepper, allspice, cardamom, chili pepper, cinnamon, clove, bay leaf, cayenne, cumin, garlic, onion powder, oregano, paprika, turmeric, ginger, nutmeg, basil, coriander, tarragon, parsley, sage, marjoram, chives, mint, and the like. Spices can therefore include any material that adds a flavor or texture component to the food product.

Food product 5 can include one or more oils. Any suitable oil can be used, including (but not limited to) canola oil, vegetable oil, olive oil, corn oil, palm oil, sunflower oil, soybean oil, safflower oil, peanut oil, coconut oil, cottonseed oil, or combinations thereof.

The food product can optionally include one or more dried or fresh fruits, such as (but not limited to) cranberries, raspberries, raisins, bananas, strawberries, apricots, pineapples, cherries, mangoes, apples, blueberries, raspberries, coconut, elderberry, pears, and the like. When dried, the fruit pieces can be osmotically dehydrated and/or vacuum fried to have a moisture content of less than about 4% by weight. The fruit can be in any form, such as whole, chopped, sliced, etc.

Food product 5 can optionally include one or more candies, such as (but not limited to) chocolate, butterscotch, marshmallows, caramel, jellies, jellybeans, fudge, icing, toffee, cocoa, peanut butter, and the like. The term “candy” therefore refers to any sweetened or sugar-based product.

In some embodiments, the food product can include one or more additives. The term “additive” generally refers to any liquid or solid material that affects a characteristic of food product 5. For example, suitable additives can include one or more preservatives, vitamins, minerals, colorings, herbal additives (echinacea, St. Johns' Wort, etc.), antimicrobials, flavorings (vanilla, maple, mocha, coffee, etc.), and the like. Such additives are well known in the art.

The food product can have a moisture content of less than about 5 percent. The term “moisture content” refers to the percentage (by weight) of moisture present within the food product. Food product 5 can therefore have a moisture content of less than about 5, 4.5, 4, 3.5, 3, 2.5, 2, 1.5, 1, 0.5, 0.25, or 0.1 weight percent, based on the total weight of the food product. However, the presently disclosed subject matter is not limited and the food product can have a moisture content greater than the range set forth above.

The desired moisture content can be accomplished through any known method, such as the selection of low-moisture ingredients, thermogravimetric methods (oven drying, halogen/IR drying, microwave drying, etc.), and the like. The moisture content of food product 5 can be determined using standard technology, such as thermogravimetric analysis, chemical analysis (titration, calcium carbide testing), spectroscopic analysis (IR spectroscopy, microwave spectroscopy, proton NMR spectroscopy), gas chromatography, density determination, refractometry, etc. Such methods are well known in the art.

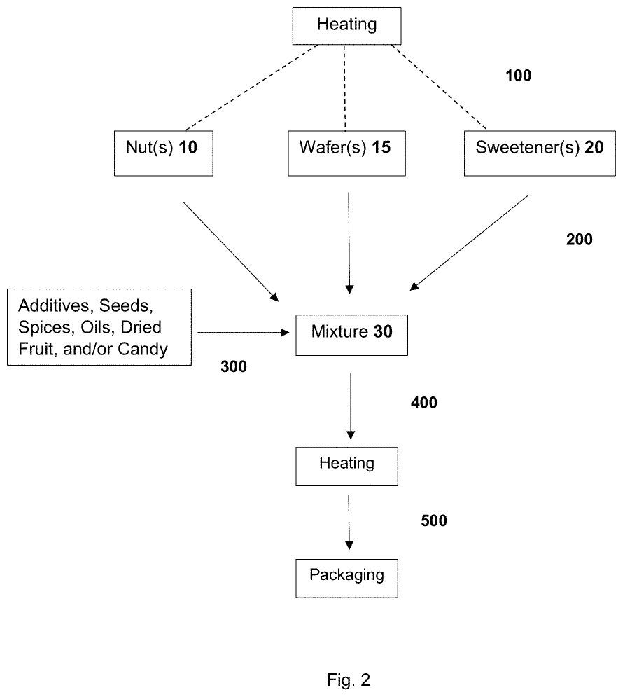

Food product 5 can be produced using any known method. FIG. 2 illustrates a schematic of one embodiment of preparing the food product. Particularly, at optional step 100, the nut(s), wafer(s), and/or sweetener(s) can be exposed to heat. For example, the food product can include roasted peanuts and/or fried corn chips. In some embodiments, the sweetener can also be exposed to heat, such as to dry out brown sugar. However, heating step 100 is optional, and can be performed for only a portion of materials 10, 15, or 20 (or not at all). At step 200, one or more nuts 10, wafers 15, and/or sweeteners 20 can be combined together to form mixture 30. Thus, each of the components of the food product can be processed (if necessary) in different streams, weighed, and then combined together. The combining of step 200 can be performed using any known mechanism, such as mixing by hand, using a mechanical mixer and/or blending apparatus, use of a tumbler, and the like.

As shown in optional step 300, one or more additives can also be incorporated into mixture 30. In some embodiments, the mixture can be in the form of a set of loose snack mix that can be accessed easily by a consumer (e.g., grabbing a handful of the food product). The term “loose snack” also includes embodiments wherein the food product is produced in clusters (e.g., an agglomeration of a plurality of nuts, wafers, sweetener and/or optional ingredients held together by a binder such as oil, wax, molasses, honey, etc.).

At optional step 400, the mixture can be heated, such as to toast the mixture. Alternatively, heating step 400 can include baking the mixture at temperatures of about 200-500° C. for about 1-90 minutes. Thus, mixture 30 can be baked at a temperature of at least about (or no more than about) 200, 225, 250, 275, 300, 325, 350, 375, 400, 425, 450, 475, or 500° C. The mixture can be baked for at least about (or no more than about) 1, 5, 10, 15, 20, 25, 30, 35, 40, 45, 50, 55, 60, 65, 70, 75, 80, 85, or 90 minutes. However, the presently disclosed subject matter is not limited and can be baked at a lower or greater temperature and/or for a longer or shorter period of time than those given above.

Optional heating step 400 is not limited to baking, and any method of applying heat to mixture 30 can be used (e.g., frying, toasting, searing, and the like).

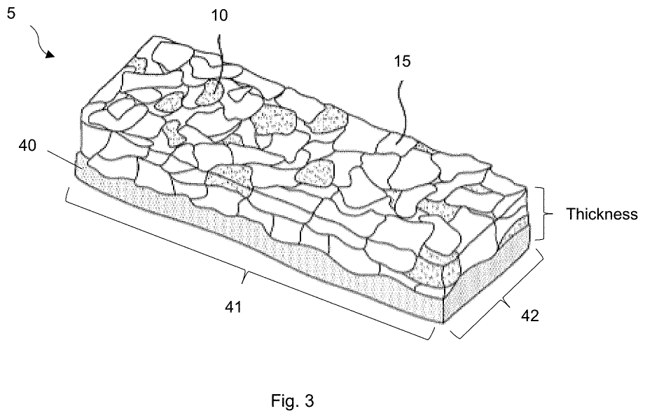

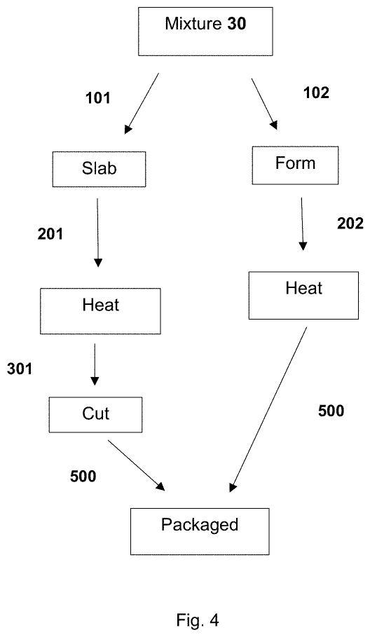

In some embodiments, mixture 30 can be formed into snack bars 35, either before or after heating at step 400, as illustrated in FIG. 3. Any conventional method can be used. For example, as shown at steps 101, 201 in the schematic of FIG. 4, mixture 30 can be formed into a slab with a desired thickness (e.g., about 0.25-1.5 inches) and the slab can be exposed to heat (e.g., baked for about 5-60 minutes at about 300-450° C.). It should be appreciated that any method of heating the slab can be used (e.g., baking, frying, steaming, sautéing, and the like). Further, the presently disclosed subject matter also includes embodiments wherein the slab is not heated. The slab can then be cut into snack-sized bars with any desired length and thickness at step 301.

Alternatively, the bars can be sized and shaped prior to heating, such as on a baking sheet or in a mold. Particularly, mixture 30 can be shaped as desired by the user at step 102. The shaped bars can then be optionally exposed to heat at step 202 (e.g., baked or fried) for a desired amount of time to produce a snack bar. In some embodiments, heat is not required to form the snack bar.

The term “bars” broadly refers to the formation of the mixture into any pre-determined shape. For example, the shape of a bar can be (but is not limited to) a square, rectangle, circle, oval, triangle, heart, “T”, “L”, or abstract shape. In some embodiments, at least one face of bar 35 can optionally be dipped in coating 40 (e.g., chocolate, caramel, butterscotch, yogurt, etc.).

When formed into bars, the food product can have any desired dimension. For example, the bars can have a length 41 and/or width 42 of about 1-6 inches. Thus, the bars can have a length and/or width of at least about (or no more than about) 1, 1.5, 2, 2.5, 3, 3.5, 4, 4.5, 5, 5.5, or 6. The bar can further have any desired thickness 43 (e.g., about 0.5-2 inches). However, it should be appreciated that the presently disclosed subject matter is not limited and the bars can be configured with a length, thickness, and/or width greater or smaller than the ranges given above. The term “length” refers to the longest dimension in the longitudinal direction (e.g., along an x-axis). The term “width” refers to the longest dimension in the transverse direction (e.g., along a y-axis). The term “thickness” refers to the direction perpendicular to the longitudinal direction (e.g., along a z-axis).

After the food product is in the final form (e.g., loose mixture, bar form, and/or clusters), the product can be packaged at step 500. The packaging step can take any desired form, according to conventional methods. As a result of the low moisture content of food product 5, each food product component can have a crisp texture, allowing the components to be packaged with a long shelf life because moisture will not migrate from one food to another.

The produced food product can have any desired amount of fat, saturated fat, trans-fatty acids, sodium, carbohydrate, fiber, whole grains, and/or protein. For example, food product 5 can have less than about 15, 10, 8, or 5 grams of fat per serving (e.g., per ½ cup snack mix or per bar). The term “fat” refers to all fats, triglycerides, and oil molecules of any size, structure or function. The term “per serving” refers to the amount of food product intended to be (or packaged so as to be) consumed in a single sitting. In some embodiments, a single serving is about 30-50 grams of food product (e.g., about 30, 35, 40, 45, or 50 grams).

In some embodiments, the disclosed food product can have less than about 5, 4, 3, 2, or 1 gram of saturated fat and/or trans fatty acids. The term “saturated fat” refers to a type of fat in which the fatty acid chains have all or predominantly all single bonds. “Trans fat” refers to a monoglyceride, diglyceride or triglyceride molecule that comprises at least one esterified fatty acid molecule that has a trans configuration (i.e., a trans fatty acid).

Food product 5 can have less than about 500, 450, 400, 350, 300, 250, 200, 150, 100, or 50 milligrams of sodium.

The produced food product can have less than about 20, 18, 16, 14, 12, 10, 8, 6, 4, or 2 grams of carbohydrates. The term “carbohydrate” encompasses the wide variety of chemical compounds having the general formula CH₂O.

In some embodiments, food product 5 can have at least about 1, 2, 3, 4, 5, 6, 7, 8, 9 or 10 grams fiber and/or at least about 2, 3, 4, 5, 6, 7, 8, 9, 10, 11, 12, 13, 14, 15, 16, 17, 18, 19, or 20 grams whole grains. The term “fiber” refers the portion of plant-derived food that cannot be completely broken down by human digestive enzymes. Fiber can include soluble fiber and/or insoluble fiber. The term “whole grains” includes grains wherein the hull is peeled off without grinding the grain (e.g., soy, peas, lentils, wheat-based, corn-based, sesame, etc.).

In some embodiments, the disclosed food product can have at least about 1, 2, 3, 4, 5, 6, 7, 8, 9, 10, 11, or 12 grams of protein. The term “protein” refers to large biomolecules or macromolecules comprising one or more long chains of amino acid residues.

It should be appreciated that the presently disclosed subject matter is not limited, and food product 5 can have an amount of fat, saturated fat, trans-fatty acids, sodium carbohydrate, fiber, whole grains, and/or protein that is outside the ranges gives above.

Advantageously, food product 5 is not only nutritious, it is also flammable and can be burned as desired by the user. The food product can therefore be used as a fuel source. Specifically, the food product can be used in place of or in addition to firewood and the like and can be easily ignited to produce a consistent and continuous flame.

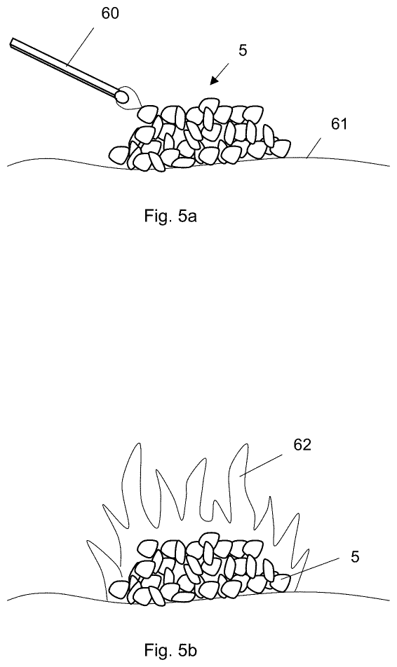

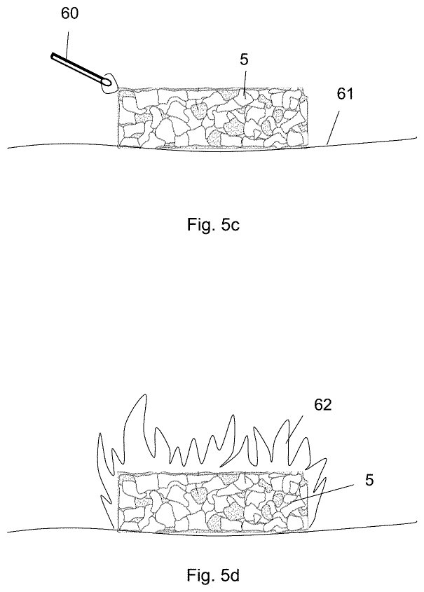

In use, food product 5 can be burned using any of a wide variety of fire sources (e.g., lighter, match). Specifically, the match (or similar device) is applied to at least a portion of the food product. For example, as shown in FIG. 5a, a portion of loose food product 5 can be stacked or positioned on support surface 61 (e.g., the ground, a grate, etc.). In some embodiments, food product 5 can be mixed with sticks, leaves, and other combustible materials. The food product can then be directly contacted with fire source 60. The flame will then spread and burn along the remainder of the food product. Thus, the food product readily burns, providing light and/or heat via fire 62 as shown in FIG. 5b. The food product continues to burn until ashes remain. Thus, at least about 50-100 percent of the food product can burn (e.g., at least/no more than about 50, 60, 70, 80, 90, or 100 percent of the food product). Food product 5 can be burned in any form, such as loose or in the bar form illustrated in FIGS. 5c and 5d. In some embodiments, the food product packaging can also be burned (e.g., especially when the packaging is constructed from paper).

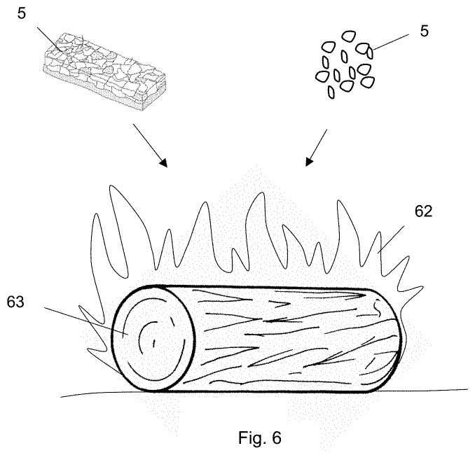

In addition, food product 5 can be added to an existing fire as an added fuel source, as shown in FIG. 6. Specifically, the disclosed food product can be used to maintain or enhance a fire. The method comprises first building a fire, commonly done through the use of logs, sticks, and other combustible materials 63. Once the fire has been started, a quantity of food product 5 can be added to the existing fire (i.e., one that has been previously lit). The food product will burn, thereby providing added heat and/or light source.

It should be appreciated that any desired quantity of food product 5 can be used to start and/or maintain a fire (e.g., a campfire).

While food product 5 has been shown and described in connection with lighting of logs in a campfire, it should be understood that the food product can be used in any application where it is desired to ignite combustible material (e.g., igniting wood in a wood stove, igniting charcoal in a grill, and the like).

Advantageously, the disclosed food product can therefore be used as both a food source and a fuel source (e.g., it can be burned).

The disclosed food product provides a simple, efficient and effective means of starting and/or feeding a fire.

Food product 5 is further an inexpensive way to provide energy (e.g., food source) and start and/or maintain a fire, such as when camping.

It should be appreciated that additional benefits of the presently disclosed subject matter would be apparent to those of ordinary skill in the art after careful review of the subject matter herein.

What is claimed is:

1. A food product, comprising:
about 5-95 weight percent of one or more nuts, based on the total weight of the food product;
about 5-70 weight percent of one or more wafers, based on the total weight of the food product; and
about 0.1-5 weight percent of one or more sweeteners, based on the total weight of the food product;
wherein the edible food product is flammable.

2. The food product of claim 1, further comprising about 0.1-5 weight percent of one or more additives, based on the total weight of the food product, wherein the one or more additives are selected from the group consisting of one or more seeds, spices, oils, dried fruits, candies, preservatives, vitamins, minerals, colorings, herbal additives, antimicrobials, or flavorings.

3. The food product of claim 1, comprising a moisture content of about 0-5 weight percent, based on the total weight of the food product.

4. The food product of claim 1, configured in loose, clustered, or bar form.

5. The food product of claim 1, wherein the nuts are selected from pecans, almonds, cashews, pistachios, peanuts, macadamia nuts, hazelnuts, chestnuts, filberts, palm nuts, pine nuts, brazil nuts, or combinations thereof.

6. The food product of claim 1, wherein the wafers are selected from corn chips, tortilla chips, potato chips, crackers, pretzels, croutons, breakfast cereals, popcorn, rice cakes, or combinations thereof.

7. The food product of claim 1, wherein the sweeteners are selected from natural sugars, artificial sugars, or combinations thereof.

8. The food product of claim 1, wherein the food product has been baked, fried, seared, or smoked.

9. The food product of claim 8, wherein the food product has been baked at a temperature of about 200-500° C. for about 1-90 minutes.

10. The food product of claim 1, comprising less than about 15 grams of fat per serving.

11. The food product of claim 1, comprising less than about 5 grams of saturated fat per serving.

12. The food product of claim 1, comprising less than about 20 grams of carbohydrates per serving.

13. The food product of claim 1, comprising 1-10 grams of fiber and about 2-20 grams whole grains per serving.

14. The food product of claim 1, comprising about 1-12 grams of protein per serving.

15. A method of starting a fire, the method comprising:
contacting flammable food product with a fire source, wherein the food product comprises:
about 5-95 weight percent of one or more nuts, based on the total weight of the food product;
about 5-70 weight percent of one or more wafers, based on the total weight of the food product; and
about 0.1-5 weight percent of one or more sweeteners, based on the total weight of the food product;
allowing the food product to burn, thereby starting a fire.

16. The method of claim 15, wherein at least about 90 percent of the food product burns.

17. The method of claim 15, wherein the food product is configured in loose, clustered, or bar form.

18. The method of claim 15, wherein the food product has a moisture content of about 0-5 weight percent, based on the total weight of the food product.

19. The method of claim 15, wherein the food product has been baked at a temperature of about 200-500° C. for about 1-90 minutes.

20. The method of claim 15, wherein the food product has been baked, fried, seared, or smoked.
